(19) United States
(12) Patent Application Publication
(10) Pub. No.: US 2025/0083092 A1
(43) Pub. Date: Mar. 13, 2025

(54) TASK-SPECIFIC IONIC LIQUID-DERIVED SYSTEM FOR SELECTIVE OXYGEN PRODUCTION

(71) Applicant: Battelle Memorial Institute, Richland, WA (US)

(72) Inventors: Deepika Malhotra, Richland, WA (US); Eric D. Walter, West Richland, WA (US); Jared O. Kroll, Richland, WA (US); David J. Heldebrant, Richland, WA (US); Yuan Jiang, Richland, WA (US)

(21) Appl. No.: 18/804,840

(22) Filed: Aug. 14, 2024

Related U.S. Application Data
(60) Provisional application No. 63/532,597, filed on Aug. 14, 2023.

(51) Int. Cl. B01D 53/04; B01D 53/047; B01J 20/22

(52) U.S. Cl. CPC B01D 53/0462; B01D 53/0476; B01J 20/22; B01D 2252/30; B01D 2253/20; B01D 2257/104

(57) ABSTRACT

Disclosed herein are task-specific ionic liquids and methods of utilizing such for separation of oxygen from combined streams. For example, disclosed are oxygen specific ionic liquids for separation of oxygen (for example, molecular oxygen, O₂) from oxygen-containing streams such as air. In a particular disclosed example, molecules of a TEMPO-derived task-specific ionic liquids form a reversible complex with oxygen, enabling a reversible chemo-selective oxygen absorbing liquid. In examples, systems utilizing the task-specific ionic liquid utilize temperature swing regeneration to release the bound oxygen and to regenerate the task-specific ionic liquid.

### CROSS-REFERENCE TO RELATED APPLICATIONS

This application claims the benefit of U.S. Provisional Patent Application No. 63/532,597, filed Aug. 14, 2023, which is incorporated by reference herein in its entirety.

### STATEMENT OF FEDERALLY SPONSORED RESEARCH OR DEVELOPMENT

This invention was made with government support under Contract No. DE-AC0576RL01830 awarded by the United States Department of Energy. The government has certain rights in the invention.

### BACKGROUND

Current commercial air separation technologies use cryogenic distillation or vacuum pressure swing adsorption to produce high purity oxygen. Cryogenic air separation utilizes air liquefaction and distillation to separate nitrogen, oxygen, and argon. Air liquefaction begins below −140° C. and is an energy intensive process. In some situations, to prevent local blackouts when connected to a local power grid, air liquefaction plants will often curtail production during hot summer months to reduce their energy demand on the grid. Cryogenic distillation can provide nearly pure oxygen, however, it is often only economically viable at relatively high oxygen production levels of 100 tonnes/day to 7,000 tonnes/day. In vacuum pressure swing adsorption, mildly pressurized air is applied to molecular sieve beds that absorb nitrogen and other impurities; a vacuum may be utilized to regenerate the beds. However, these systems require large beds of sorbents due to their low gravimetric capacity of oxygen and do not produce high purity oxygen.

### SUMMARY

Disclosed herein are task-specific ionic liquids for separation of oxygen from combined streams. For example, disclosed are oxygen specific ionic liquids for separation of oxygen (for example, molecular oxygen, O₂) from oxygen-containing streams such as air.

In a particular disclosed example, molecules of a (2,2,6,6-Tetramethylpiperidin-1-yl)oxyl (TEMPO)-derived task-specific ionic liquids form a weakly-coordinating and reversible complex with oxygen, enabling a reversible chemo-selective oxygen absorbing liquid. In examples, systems utilizing the task-specific ionic liquid utilizes temperature swing and/or pressure swing regeneration to capture the bound oxygen and to regenerate the task-specific ionic liquid.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an example structure of a TSIL-TEMPO molecule as disclosed.

FIG. 2A illustrates an example structure of a TSIL-TEMPO molecule with multiple free radical sites as disclosed.

FIG. 2 illustrates an example synthesis method of a TSIL-TEMPO molecule as disclosed.

FIG. 3A depicts EPR spectra of an oxygen specific ionic liquid as described herein, according to an example.

FIG. 3B depicts double integrated spectra over time and pressure variance, according to an example.

FIG. 4 depicts a fraction of oxygen bound as a function of pressure, according to an example.

FIG. 5 depicts the fraction of oxygen bound as a function of millimoles of oxygen, according to an example.

FIG. 6 depicts oxygen sorption profiles several temperatures as a function of pressure, according to an example.

FIG. 7 illustrates an example potential supramolecular complex and example potential monodentate complex.

FIG. 8 illustrates an example synthesis method of a TSIL-TEMPO molecule with multiple free radical sites as disclosed.

FIG. 9A depicts TSIL-TEMPO biradical analogue compound oxygen absorption capacity as a function of pressure, according to an example.

FIG. 9B depicts properties of the TSIL-TEMPO biradical analogue compound oxygen loading as a function of pressure, according to an example.

FIG. 10 depicts oxygen absorption of the TSIL-TEMPO biradical analogue compound at several pressures as a function of temperature, as compared to TEMPOL, according to an example.

FIG. 11 illustrates an example process wherein an oxygen specific ionic liquid is utilized as a solvent liquid.

FIG. 12 illustrates an example process wherein an oxygen specific ionic liquid is utilized as loaded onto a substrate.

FIG. 13 illustrates an example method for capturing molecular oxygen from a stream containing molecular oxygen.

FIG. 14A depicts the impact of operating pressure economic measures of an example disclosed technology, according to an example.

FIG. 14B depicts the impact of operating pressure environmental measures of an example disclosed technology, according to an example.

FIG. 15 depicts a comparison of an example system with the commercial technology, according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. It should be understood that this invention is not limited to the particular methodology, protocols, and reagents, etc., described herein and as such may vary. The following detailed description is therefore not to be taken in a limiting sense, and the scope of the present disclosure is defined by the appended claims and their equivalents.

Unless defined otherwise, all technical and scientific terms used herein have the same meaning as those commonly understood to one of ordinary skill in the art to which this invention pertains.

For the purposes of this application the following terms shall have the following meanings:

As used herein and in the claims, the singular forms “a,” “an”, and “the” include the plural reference unless the context clearly indicates otherwise.

Other than in the operating examples, or where otherwise indicated, all numbers expressing quantities of ingredients or reaction conditions used herein should be understood as modified in all instances by the term “about.” The term “about” when used herein in connection with numerical values means±20% and with percentages means±4%.

As used herein, the term “comprising” refers to a composition, compound, formulation, or method that is inclusive and does not exclude additional elements or method steps.

As used herein, the term “consisting of” refers to a compound, composition, formulation, or method that excludes the presence of any additional component or method steps.

Because current air separation methods require great amounts of energy, may be only economical at very large oxygen production rates, and/or require large amounts of less efficient sorbent, improved air separation/oxygen production systems are desired. Oxygen, especially pure or high-purity oxygen, is a commercial feedstock often utilized as a combustion feed, in medical applications, chemical applications, welding and steel work, manufacturing, industrial processes, as a fuel (for example, in fuel cells or combustion), mining applications, and cryogenic applications, among other uses. Having high-purity oxygen available in various regions provides benefits to users of the oxygen. For example, when high-purity oxygen is readily available for modular gasification systems, capital investment requirements may be decreased, and location flexibility may be increased. In another example, having high-purity oxygen available can increase reliability of healthcare for hospitals and other medical users or providers of oxygen to patients or for cryogenic medical purposes. In another example, modular systems may process various types of coal into clean syngas to enable the production of affordable, reliable, and low-cost electricity, hydrogen, high-value chemicals, liquids and fuels; these systems require a feed of high purity oxygen. In another example, such systems may be integrated into larger systems, such as oxy-combustion or oxidation technologies.

Disclosed herein are methods and systems wherein a system, for example, a modular system, includes a solvent-based capture and thermal or physical release of oxygen, to enable “oxygen on demand” for a variety of downstream users. An example solvent includes a task-specific ionic liquid having an unpaired electron, which, may form a complex with oxygen that is selective enough to efficiently separate oxygen from a feed air stream, but weak enough to enable this fluid to be thermally or physically reversible (e.g., by temperature and/or pressure), allowing for capture of the separated oxygen and regeneration of the solvent. The task-specific ionic liquid has high gravimetric capacities of oxygen, via one of several complexes potentially formed, for example, a diamagnetic supramolecular complex or a monodentate complex.

In examples, the disclosed methods and systems require less energy for oxygen separation than currently available commercial counterparts. In examples, the disclosed methods utilize a low temperature (for example, between about 30° C. to about 80° C.) air separation unit to produce high purity oxygen (for example, greater than 90% oxygen). In examples, the disclosed systems may be operationally and/or commercially efficient at a 1-5 MWe level. In some examples, the disclosed systems may demonstrate operational and/or commercial efficiency with an energy efficiency of less than 200 kW-h per tonne of oxygen produced while delivering high purity oxygen; in some examples, the disclosed systems may demonstrate operational and/or commercial efficiency at a 1-5 MWe capacity while delivering high purity oxygen; in some examples, these systems will utilize temperature swing assisted regeneration.

Ionic liquids are generally known to have relatively low vapor pressures. Refer generally to Y. U. Paulechka, et al., Vapor pressure and thermal stability of ionic liquid 1-butyl-3-methylimidazolium Bis(trifluoromethylsulfonyl)amide, Thermochimica Acta, Vol. 439, Issues 1-2, pp. 158-160 (2005), for an example discussion of vapor pressures of ionic liquids. The disclosed task-specific ionic liquids (TSILs) are salts with low melting points, (which may be liquid as pure salts near room temperature). The disclosed TSILs have low or negligible vapor pressure due to strong ionic interaction, high thermal stability, and non-flammability. This low vapor pressure is an advantageous characteristic, as substances with a high vapor pressure may evaporate too quickly to be useful, or may require less than ideal operating conditions to prevent evaporation.

The disclosed TSILs often have structure and properties that allow them to have “chemical tunability,” meaning the molecules can be designed with desirable characteristics suitable for oxygen separation from air

Oxygen constitutes a smaller fraction of air than nitrogen (e.g. air includes about 21% oxygen versus about 78% nitrogen), therefore, the disclosed oxygen-selective materials provide an advantage in oxygen separation from air over nitrogen-selective technologies, as a smaller system volume and energy footprint may be possible.

Chemicals as disclosed herein having a free radical have the potential to react with and bind with oxygen. Some such compounds may include an organic free radical portion. Some compounds may include a nitroxide portion. Some compounds may have rings of 5 or 6 members.

One particular example of such a compound is (2,2,6,6-Tetramethylpiperidin-1-yl)oxyl (hereinafter TEMPO), having the chemical formula (CH₂)₃(CMe₂)₂NO. TEMPO is a heterocyclic compound having a free radical; TEMPO is a stable aminoxyl radical. The reactive radical is well shielded by the four methyl groups. Delocalization of the radical forms a two-center three-electron nitrogen-oxygen bond, contributing to stability of the molecule. In an example, steric protection is provided by four methyl groups adjacent to the aminoxyl group; two on each side adjacent to the aminoxyl group. An example TEMPO structure is shown below as Formula I.

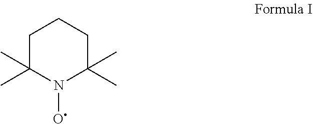

In some examples, the functional groups adjacent to each side of the aminoxyl group may include groups other than methyl groups, such as longer hydrocarbon chains, rings, or other functional groups. In example, altering these functional groups provides the ability to tune the molecule to alter stability and/or reactivity. An example TEMPO structure depicting generic locations for various functional groups is shown below as Formula II. Groups R₁-R₅ in Formula II represent functional groups that may be customized/altered in order to provide specific benefits or characteristics to the molecule.

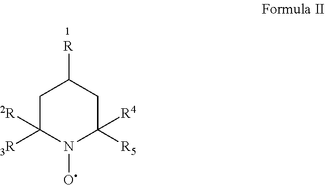

TEMPO has several currently-known laboratory and industrial uses, including use as a radical marker, as a reagent in organic synthesis, in controlled radical polymerization. In such past currently-known uses, it has been noticed that the presence of oxygen in the systems contributes to inefficiencies in such systems. The present disclosure, however, studies and makes advantage use of this interaction previously viewed as a disadvantage in other systems.

In some examples, TEMPO can have a vapor pressure that contributes to a rate of evaporation that can add difficulty to processes that utilize it. To address that issue, the present disclosure synthesizes molecules having the advantageous stable, shielded aminoxyl radical of TEMPO that incorporate the beneficial low vapor pressure of an ionic liquid (for example, a TSIL). Such disclosed molecules selectively bind to oxygen, allow for release of the oxygen from the molecule at different thermal or physical conditions, that have desirable vapor pressures, and that can be tuned for desirable affinity characteristics. An example of such a TSIL-TEMPO oxygen selective ionic sorbent structure, where the TSIL is derived from imidazole, is shown below as Formula III. The ionic portion may include an imidazolium ion. An example of such a TSIL-TEMPO oxygen selective ionic sorbent structure, where the TSIL is derived from imidazole, depicting generic locations for various functional groups is shown below as Formula IV. In the below Formulas III and IV, the “X” group represents a negative ion, which may be ionically attracted to or bonded with the positive ion at the ionic portion. Groups R₁-R₄ in Formula IV represent functional groups that may be customized/altered in order to provide specific benefits or characteristics to the molecule. The example TSIL-TEMPO molecules disclosed herein may have a vapor pressure less than a vapor pressure of TEMPO or TEMPOL.

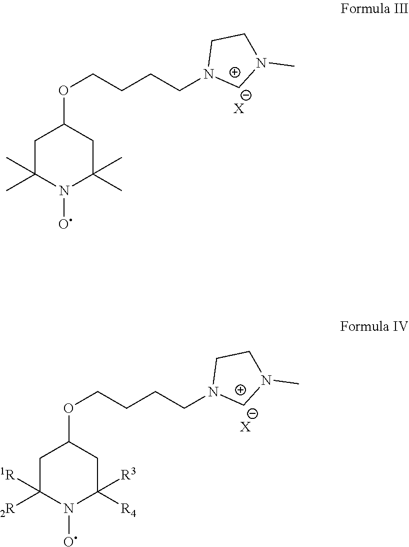

In some examples, Formula II may also represent a TEMPO-derived molecule as described herein, wherein R₁ of Formula 2 represents an ionic portion (for example, an ionic portion as derived from an ionic liquid, for example, an imidazolium ion). In some examples, ionic liquids may include imidazole and its derivatives, for example, 1-methylimidazole.

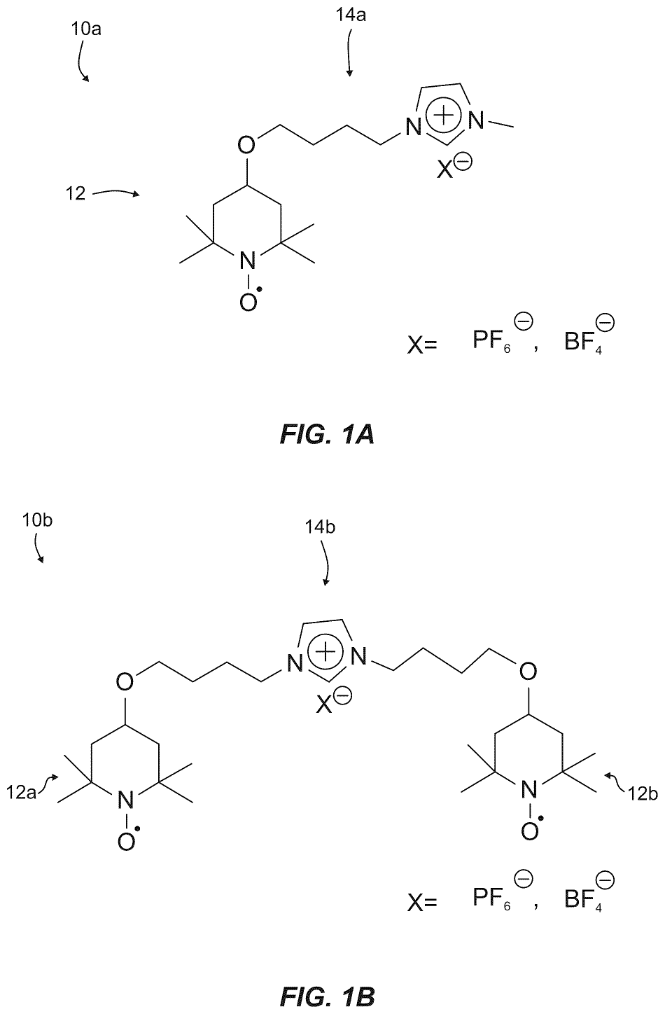

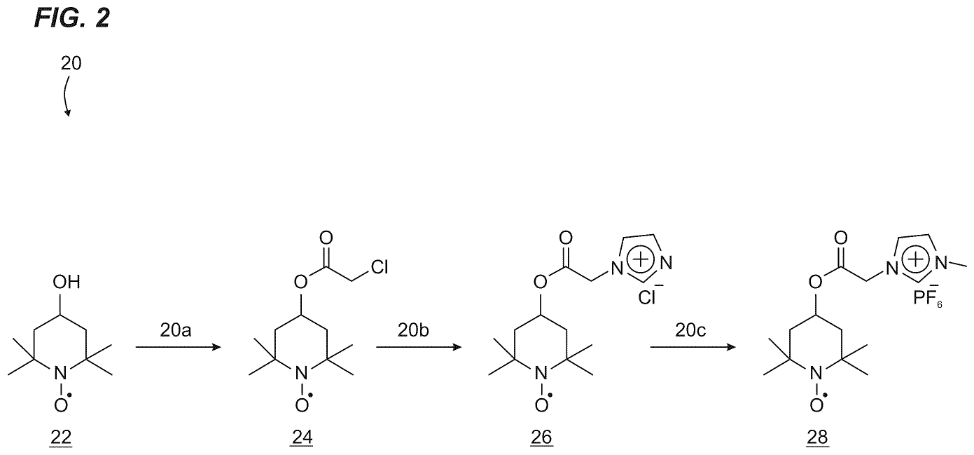

FIG. 1A illustrates an example structure of a TSIL-TEMPO molecule 10a as disclosed. TSIL-TEMPO molecule 10a comprises an ionic portion 14a (for example, derived from a TSIL). Connected to the ionic portion 14a (in examples, by a hydrocarbon chain) is a radical portion 12 (for example, a heterocyclic aminoxyl radical such as one derived from TEMPO). In FIG. 1A, X represents a negatively charged ion attracted to the positive charge of the ionic liquid portion (in some examples, a negative PF₆ ion or BF₄ ion). Such a molecule may, in some examples, be synthesized by a method such as that shown in FIG. 2. FIG. 2 illustrates an example synthesis method 20 of a TSIL-TEMPO molecule as disclosed. The synthetic method 20 includes a three-step process to achieve high yields of TSIL-TEMPO molecules. The first step 20a involves the reaction of compound 22 (4-hydroxy-2,2,6,6-tetramethyl-piperdine-1-oxyl (a TEMPO-based molecule also called 4-hydroxy-TEMPO or TEMPOL)) with chloroacetic acid in the presence of dicyclohexyl carbodiimide (DCC) and 4-dimethylaminopyridine (DMAP) to yield compound 24 (chloroacetic acid 2,2,6,6-tetra-methyl-1-oxy-piperidin-4-yl ester) (achieving a 76% yield in one particular example). The compound 24 was treated with 1-methylimidazole at step 20b to yield compound 26 (achieving a 89% yield in one particular example). At step 20c, compound 26 is reacted in an exchange of counter ion with hexaflorophosphate to furnish the final TSIL-TEMPO compound 28 (achieving a 75% yield in one particular example).

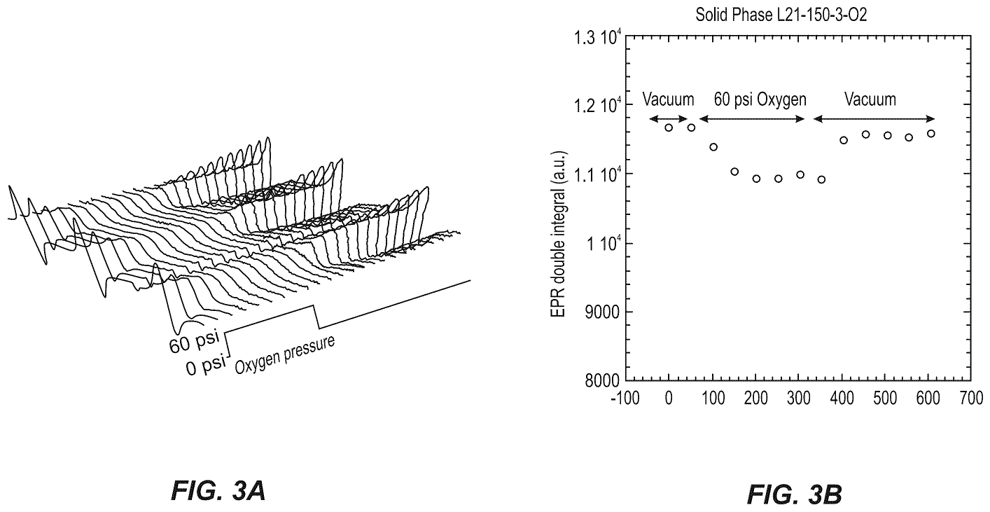

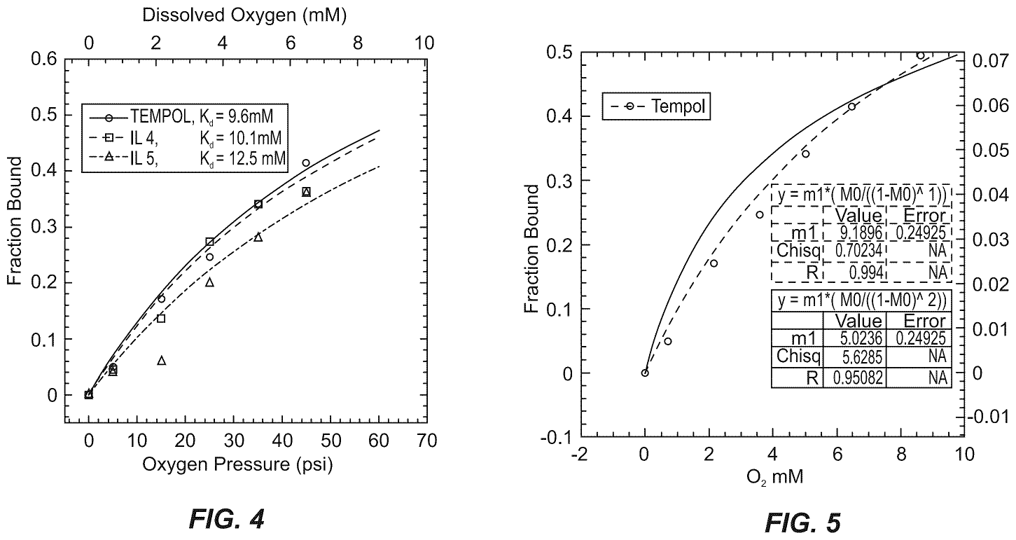

Upon completion of method 20, generated TSIL-TEMPO molecules may be characterized using proton and carbon NMR spectroscopy. In order to measure oxygen capacity and gain insight into the oxygen binding mechanism, electron paramagnetic resonance (EPR) studies were conducted on the generated TSIL-TEMPO molecules. EPR spectra were collected on a Bruker 580 Elexsys X-band spectrometer. Samples of about 10 μl were contained in a fluorinated ethylene propylene (( ) tube with an outer diameter of 4 mm od and an inner diameter of 3 mm. The top of the sample tube was connected to a manifold system that could supply either vacuum or pure oxygen at a regulated pressure. EPR spectra were recorded continuously while the oxygen pressure was varied, with each spectrum taking 50 second to record. Refer to FIG. 3A. Spectra were baselined and then double integrated in order to convert the recorded spectrum to a number proportional to the free nitroxide concentration. Refer to FIG. 3B. FIG. 3A and FIG. 3B further illustrate that under vacuum, the oxygen remains bound to the TSIL-TEMPO. As the pressure is increased (to 60 psi in the particular example shown), the oxygen is released from the TSIL-TEMPO, allowing for capture of the oxygen as well as regeneration/reuse of the TSIL-TEMPO. Oxygen-bound nitroxides will not contribute to the EPR spectrum, allowing for the detection of binding. The concentration of dissolved oxygen was calculated from the partial pressure. Data from solutions of the nitroxides in dimethyl sulfoxide (DMSO) was fit to find the dissociation constant, K_{d}. Refer to Equations 1 and 2. The binding was determined to be first order (n=1) in oxygen, and not second order in nitroxide. Refer to FIG. 4, which depicts the fraction of oxygen bound as a function of pressure. Refer also to FIG. 5, which depicts the fraction of oxygen bound as a function of millimoles of oxygen.

$$( n ) TSIL + {O}_{2} ↔ {TSIL}_{n} - {O}_{2} \qquad Equation 1$$

$${K}_{d} = \frac{{[ TSIL ]}^{n} [ {O}_{2} ]}{[ {TSIL}_{n} - {O}_{2} ]} \qquad Equation 2$$

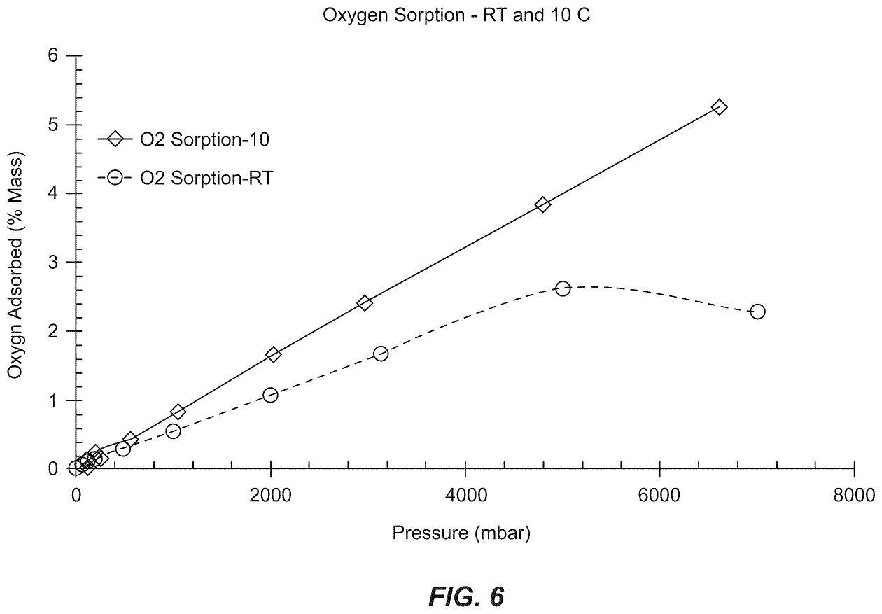

FIG. 6 depicts—high-pressure adsorption capacity and kinetics of the generated TSIL-TEMPO at two different temperatures.

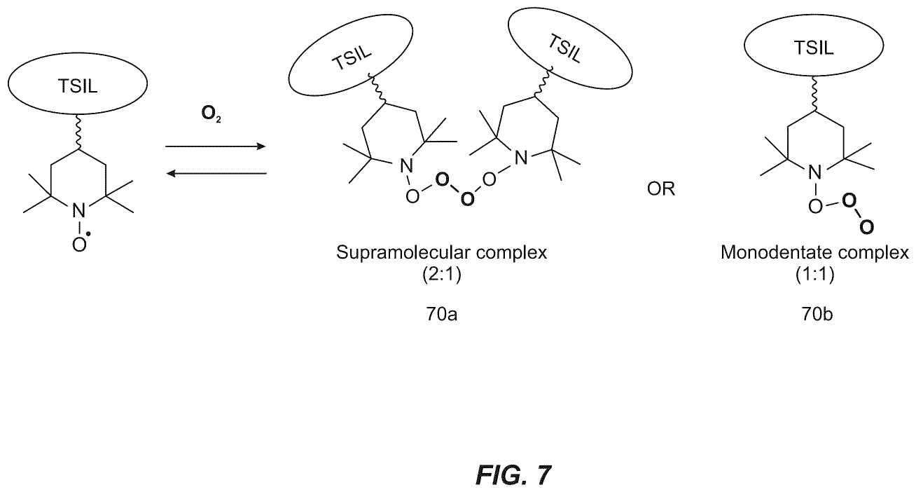

In some examples, a TSIL-TEMPO molecule as described herein may bind to oxygen as a monodentate complex (1:1) or a supramolecular complex (2:1). FIG. 7 illustrates a potential supramolecular complex 70a that has the free radical site of a first TSIL-TEMPO molecule bound to a first oxygen atom of molecular oxygen molecule (O2), and the free radical site of a second TSIL-TEMPO molecule bound to a second oxygen atom of the molecular oxygen molecule. FIG. 7 also illustrates a potential monodentate complex 70b that has the free radical site of a single TSIL-TEMPO molecule bound to one of the oxygen atoms of a molecular oxygen molecule, where the other oxygen atom of the molecular oxygen molecule remains unbound. In some examples, either one of the supramolecular complex and the monodentate complex or both of the supramolecular complex and the monodentate complex may be formed.

The paramagnetic nature of the triplet oxygen may form weak complexes with closed shell organic molecules. Since the disclosed TSIL-TEMPO has an unpaired electron that can pair up with the high-energy electrons in the antibonding orbitals of molecular oxygen, the anticipated weak complex that is formed enables this fluid to be thermally reversible. This TSIL-TEMPO can conceivably have high gravimetric capacities of oxygen, via the supramolecular 2:1 complex or the monodentate 1:1 complex.

In some examples, a TSIL-TEMPO molecule may include more than one free radical site, allowing the single molecule to bind with more than one oxygen molecule. This may increase adsorption capacity of each molecule. Such a molecule may include a TSIL portion connected on either side by a hydrocarbon chain to an aminoxyl radical portion. An example of such a TSIL-TEMPO biradical analogue (oxygen selective ionic sorbent) structure, where the TSIL is derived from imidazole, is shown below as Formula V. An example of such a TSIL-TEMPO biradical analogue (oxygen selective ionic sorbent) structure, where the TSIL is derived from imidazole, depicting generic locations for various functional groups is shown below as Formula VI. An example of such a TSIL-TEMPO biradical analogue (oxygen selective ionic sorbent) structure, where the TSIL is depicted as a functional group, depicting generic locations for various other functional groups is shown below as Formula VII. In the below Formulas V and VI, the “X” group represents a negative ion, which may be ionically attracted to or bonded with the positive ion at the ionic portion. Groups R₂-R₉ in Formulas VI and VII represent functional groups that may be customized/altered in order to provide specific benefits or characteristics to the molecule. Group R₁ in Formula VI represents functional groups that includes an ionic portion (for example, a portion derived from an ionic liquid). The ionic portion in Formulas V-VII may include an imidazolium ion. The example TSIL-TEMPO molecules disclosed herein may have a vapor pressure less than a vapor pressure of TEMPO or TEMPOL.

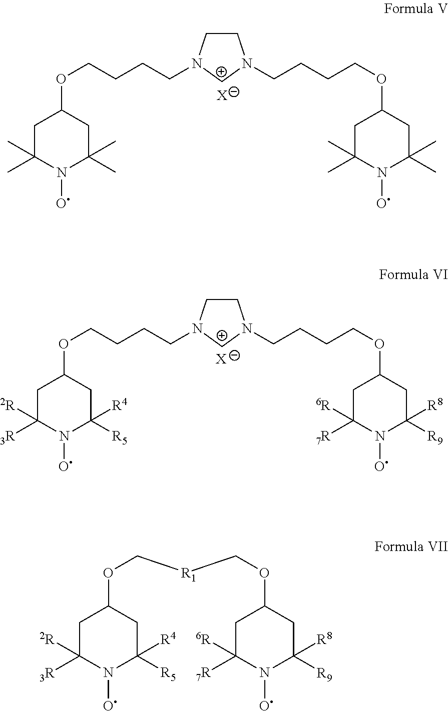

Referring to the above Formulas V-V11, in some examples, at least one of R₂, R₃, R₄, R₅, R₆, R₇, R₈, and R₉ may include a methyl group. Referring to the above Formulas V-V11, in some examples, an orientation of R₂, R₃, R₄, and R₅ may shield the first aminoxyl radical, and an orientation of R₆, R₇, R₈, and R₉ may shield the second aminoxyl radical. Referring to the above Formulas V-V11, in some examples, R₁ is derived from an ionic liquid, such as imidazole or 1-methylimidazole. In some examples, altering the length and/or flexibility of the hydrocarbon chain linking R₁ to the oxygen atom of each radical portion could allow for tuning of the oxygen affinity of the molecule. Too low of an affinity, and high oxygen yields may not be achieved. Too high of an affinity, and the oxygen may be difficult to remove/capture from the radical portion (and the molecule may be difficult to regenerate).

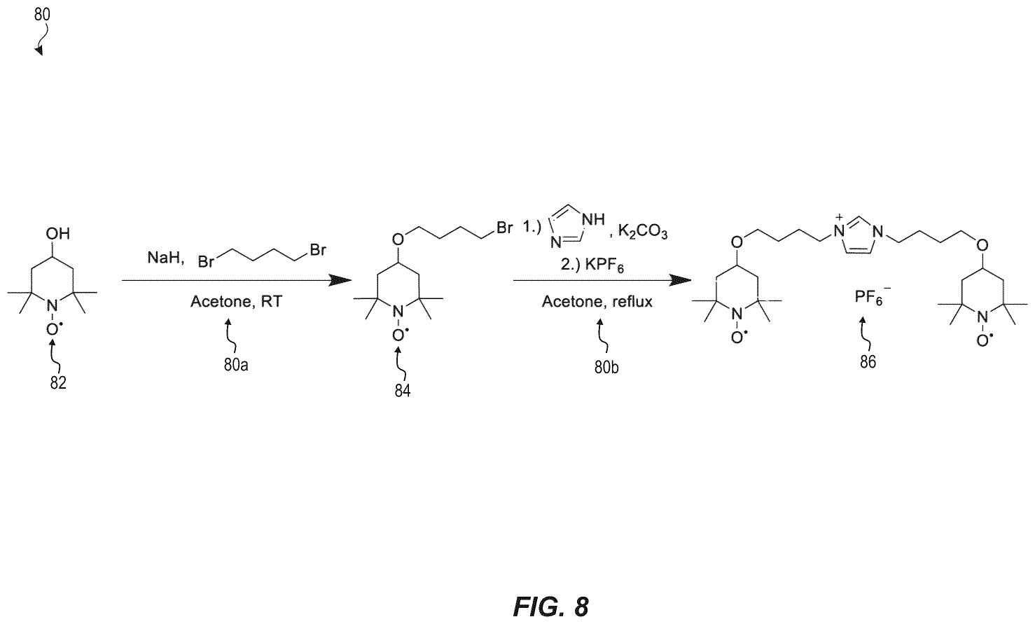

FIG. 1B illustrates an example structure of a TSIL-TEMPO molecule 10b with multiple free radical sites as disclosed. TSIL-TEMPO molecule 10b comprises an ionic portion 14b (for example, derived from a TSIL). Connected to the ionic portion 14b (in examples, each by a hydrocarbon chain) are two radical portions 12a, 12b (for example, heterocyclic aminoxyl radicals such as those derived from TEMPO). In FIG. 1B, X represents a negatively charged ion attracted to the positive charge of the ionic liquid portion (in some examples, a negative PF₆ ion or BF₄ ion). Such a molecule may, in some examples, be synthesized by a method such as that shown in FIG. 8. FIG. 8 illustrates an example synthesis method 80 of a TSIL-TEMPO molecule with multiple free radical sites as disclosed. The synthetic method 80 includes a two-step process to achieve high yields of such TSIL-TEMPO molecules. The particular example shown illustrates synthesis of a molecule with two units of TMEPO-derived portions installed on either side of a TSIL portion.

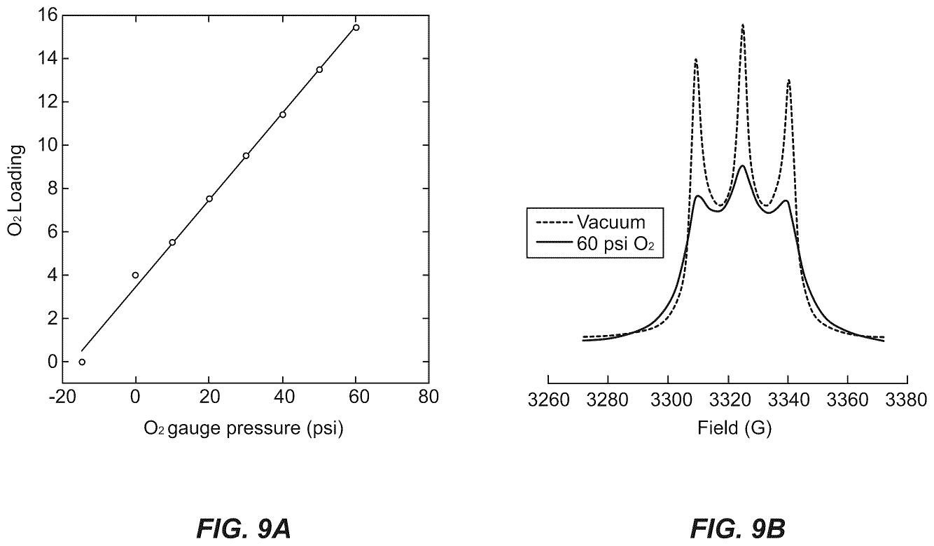

The first step 80a involves compound 82 (4-hydroxy-2,2,6,6-tetramethyl-piperdine-1-oxyl (a TEMPO-based molecule)) with 1,4-dibromobutane and sodium hydride in the presence of acetone to yield compound 84. The compound 84 was then reacted first with imidazole and potassium carbonate and second with potassium hexafluorophosphate under reflux conditions, in the presence of acetone. This yielded the TSIL-TEMPO biradical analogue compound 86. In post-generation testing (for example, as described above with regards to compound 28), the TSIL-TEMPO biradical analogue compound 86 demonstrated high oxygen absorption capacity of at least 15 weight percent at pressures of about 60 psi. Refer to FIG. 9A. FIG. 9B further illustrates properties of the TSIL-TEMPO biradical analogue compound, demonstrating a higher oxygen absorption peak under vacuum conditions than at 60 psi.

In the particular example shown, the TSIL-TEMPO biradical analogue is symmetrical, that is, the radical portions are symmetrical to each other (for example, are the same as one another) on either side of the TSIL portion. In some examples, the radical portions may be different from one another. In some examples, synthesizing a molecule in which the radical portions are different from one another may be more difficult to synthesize. In some examples, TSIL-TEMPO analogues as disclosed that are asymmetrical may be designed to be more asymmetric compared to traditional inorganic salts, which may result in the ionic charge being distributed over a larger molecular volume. Such an increased asymmetry can affect properties such as solubility, melting point, and how the TSIL-TEMPO molecules interact with other substances, allowing for tunability of the molecules.

In some examples, the TSIL-TEMPO liquids may be utilized in various processes. These processes may utilize temperature-swing regeneration, whereby altering a temperature from a first temperature to a second temperature releases bound oxygen from the TSIL-TEMPO complex. In some examples, these processes may utilize pressure-swing regeneration, whereby altering a pressure from a first pressure to a second pressure releases bound oxygen from the TSIL-TEMPO complex. These processes may also adjust operating conditions such as temperature and/or pressure, in order to customize the oxygen affinity of the TSIL-TEMPO in the process (as supported by the data above and below). In some examples, a process may operate at a first condition wherein the oxygen is chemically absorbed/bound to the TSIL-TEMPO sorbent, and at a second condition wherein the oxygen is desorbed from the TSIL-TEMPO sorbent. In some examples, a first condition includes a pressure less than about 60 psi. In some examples, first condition includes a pressure less than about 60 psi. In some examples, the first condition includes a pressure of about 60 psi. In some examples, the first condition includes a pressure of between about 50 psi and about 90 psi. In some examples, the second condition includes an ambient pressure. In some examples, the second condition includes a vacuum. In some examples, the second condition includes a partial vacuum. In some examples, the second condition includes a pressure less than a pressure at the first condition.

In some examples, the TSIL-TEMPO may be utilized as a solvent liquid, where it flows through a column, bed, or other process equipment. In some examples, the TSIL-TEMPO may be combined with (for example, mixed with or diluted into) a solvent or additional ionic liquid; this may provide the ability to adjust properties such as viscosity, reactivity, and others.

In some examples, the TSIL-TEMPO may be loaded onto a substrate. Such a substrate may include silica particles, in some examples. Silica particles may be porous, and may include, for example, mesoporous silica particles; porosity of the substrate increases surface area for loading of the TSIL-TEMPO and therefore for reactivity. Substrate particles loaded with the radical ionic liquid (for example, porous silica particles loaded with the TSIL-TEMPO) may be utilized unit operations such as columns, beds, and the like. In some examples, the substrate includes another type of particle, such as bauxite. In some examples, a substrate may include a high surface area material such as a structured packing or other solid support, where a thin film of TSIL-TEMPO may be adsorbed onto the material. Substrates loaded with TSIL-TEMPO may be suitable for utilization within a column or bed unit operation.

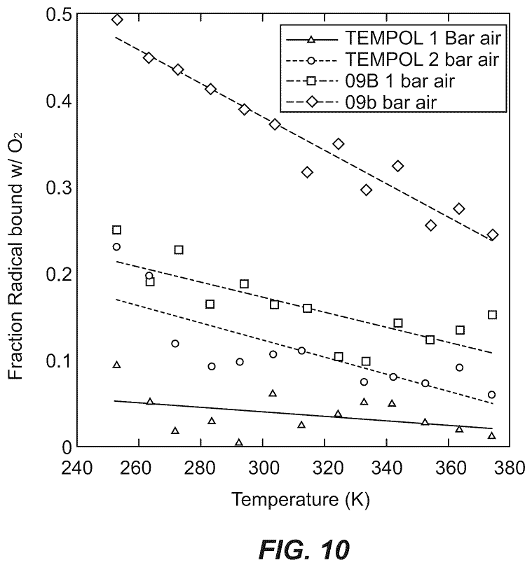

In examples, TSIL-TEMPO biradical analogue compound 86 was loaded onto silica particles (for example, porous silica particles such as DiagNano™ MCM-41 Mesoporous Silica Particles, 100 μm, 30 A Pore Size, available from CD Bioparticles, located at 45-1 Ramsey Road, Shirley, NY 11967, USA). FIG. 10 illustrates that the TSIL-TEMPO biradical analogue compound (indicated as 09B and 09b in FIG. 10 and depicted as square data points on the graph) maintains between three and four times higher loading at all temperatures than TEMPOL at the same pressure conditions. This indicates that the incorporation of the ionic liquid portion (e.g. the TSIL portion) into the molecule improves loading of the radical compound onto the silica substrate. This has advantages for the use of the radical ionic liquid compound in practical applications and processes. Without wishing to be bound by theory, it is thought that the ionic liquid portion contributes to a vapor pressure of the radical liquid, where the radical liquid does not evaporate away from the substrate as quickly as the TEMPOL evaporates away from the substrate.

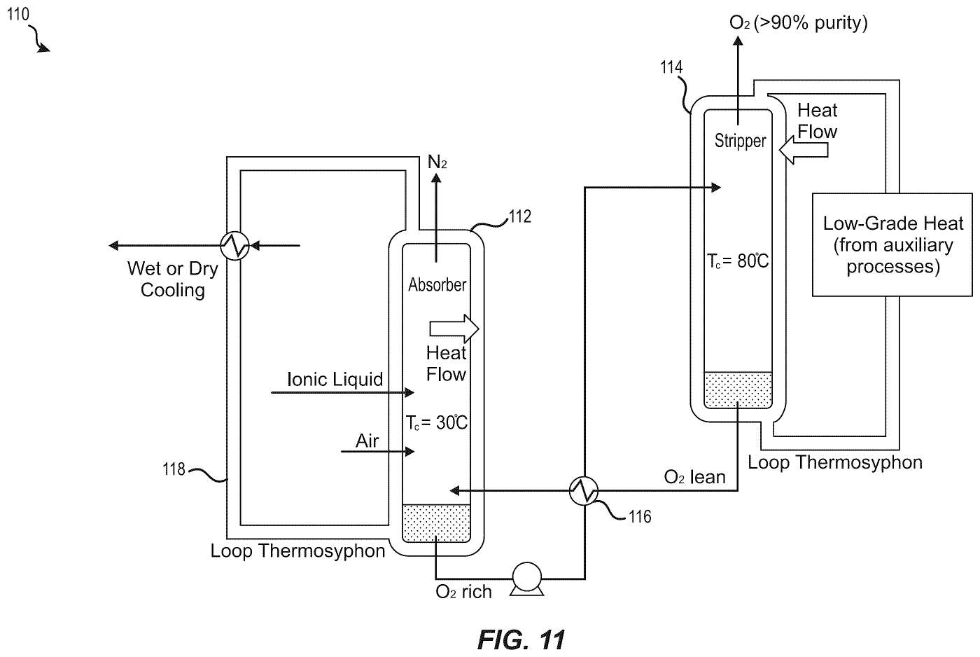

As noted above, the radical ionic liquids such as the TSIL-TEMPO compounds discussed above may be utilized in a process as a solvent liquid. Although other arrangements and processes are possible, FIG. 11 illustrates a particular example process 110 for purposes of discussion. The radical ionic liquid solvent and air (in some examples, dry air) will be fed into an absorber column 112 that is operated near room temperature (for example, between about 25° C. and about 30° C.) for high oxygen absorption capacity. Nitrogen and other light impurities will exit the top of the absorber column 112. Then, the (now oxygen-bound) radical ionic liquid solvent will be fed into a stripper column 114 where the radical ionic liquid solvent will be thermally regenerated (for example, between about 60° C. and about 80° C.), releasing the oxygen from the radical ionic liquid solvent. High purity oxygen (for example, oxygen with a purity greater than 90%) will exit the top of the stripper column 114. The remaining oxygen-lean radical ionic liquid solvent in the stripper column 114 will be fed back into the absorber column 112, exchanging heat with the oxygen-rich stream coming from the absorber column 112 (for example, using a liquid-liquid heat exchanger 116, such as a shell and tube, double tube, plate and frame, or other type). Process 110 may be utilized as a modular gasification system.

In some examples, because oxygen absorption is an exothermic process and regeneration is an endothermic process, an ultimate heat sink and heat source may be required, respectively, in addition to a thermal transport mechanism in order to maintain absorber 112 and stripper 114 column temperature stability for high uptake and regeneration. In the particular example shown, an isothermal, passive Loop Thermosyphons (LTS) 118 may be utilized.

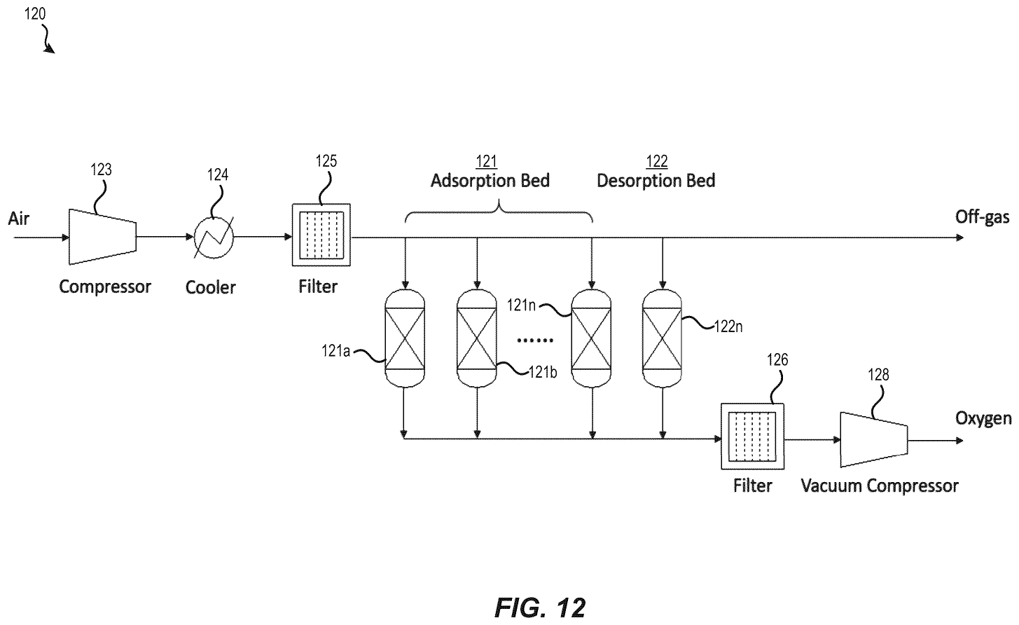

As noted above, the radical ionic liquids such as the TSIL-TEMPO compounds discussed above may be utilized in a process as loaded onto a substrate (such as a porous silica particle, for example). Although other arrangements and processes are possible, FIG. 12 illustrates a particular example process 120 for purposes of discussion. The loaded substrate is contained in an adsorption column or bed 121 (for example, a packed bed, fluidized bed, or other suitable unit operation), and air (in some examples, dry air) is fed into the adsorption bed. In some examples, a plurality of adsorption beds 121a, 121b, through 121n may be arranged, for example, in series, to increase process throughput. In examples, the adsorption bed(s) 121 may be operated near room temperature (for example, between about 25° C. and about 30° C.). The oxygen in the air binds to the radical ionic liquid loaded onto the substrate, and the oxygen-lean air exits the adsorption bed 121. The conditions of the bed 121 may be altered in order to regenerate the radical ionic liquid in a desorption process. This is depicted in FIG. 12 as one or more desorption bed(s) 122n, however, the same bed(s) may be utilized in example processes for both adsorption and desorption operations. In some examples, some beds may be undergoing adsorption while others are undergoing desorption, so that a continuous stream of oxygen is produced. In other examples, all beds undergo adsorption and desorption at the same time, to provide a batch process. For example, thermal regeneration as discussed above may be utilized. In other examples, pressure alteration may be utilized as a method of regeneration (for example, altering from a vacuum pressure to a pressure of about 60 psi). The freed high purity oxygen flows out of the adsorption bed 121.

In some examples, the air and/or oxygen may undergo pre/post process unit operations. For example, the feed air for the adsorption bed(s) 121 may pass through unit operations such as compressor 123, cooler 124, and filter 125 in order to remove moisture, particulates, or other impurities. In some examples, the high purity oxygen may pass through unit operations such as filter 126 to remove any residual substrate or other impurities, and/or a vacuum compressor 128.

In some examples, one or more processes (including those outlined in FIG. 11, 12, or other suitable processes) may include or be included within an energy conversion system (for example, such as an on-demand portable or modular oxygen generation system, an oxy-combustion system, oxidation technologies with oxygen concentrator modules, or other system). Such an energy conversion system may include a unit operation vessel that has an inlet by which an inlet stream including molecular oxygen (for example, air) flows into the unit operation vessel. The unit operation vessel may contain a plurality of mesoporous silica particles within it, each of the plurality of mesoporous silica particles being loaded with an oxygen selective ionic liquid as described herein. The unit operation vessel may include outlet by which an outlet stream flows out of the unit operation vessel.

In some examples, in energy conversion system, the unit operation vessel includes one of a fluidized bed or a packed bed that contain the loaded substrate particles. The unit operation vessel may capable of being operated under at least the first set of conditions and a second set of conditions, where the oxygen binds to the oxygen selective ionic liquid under the first set of conditions and is released from the oxygen selective ionic liquid under a second set of conditions; thereby regenerating the oxygen selective ionic liquid. Under the second set of conditions, the molecular oxygen is released from the oxygen selective ionic liquid, and the outlet stream consists of high purity oxygen (for example, consists essentially of the released molecular oxygen).

In some examples, an energy conversion system further includes a molecular oxygen collection vessel and or oxygen processing equipment/operations downstream of the unit operation vessel.

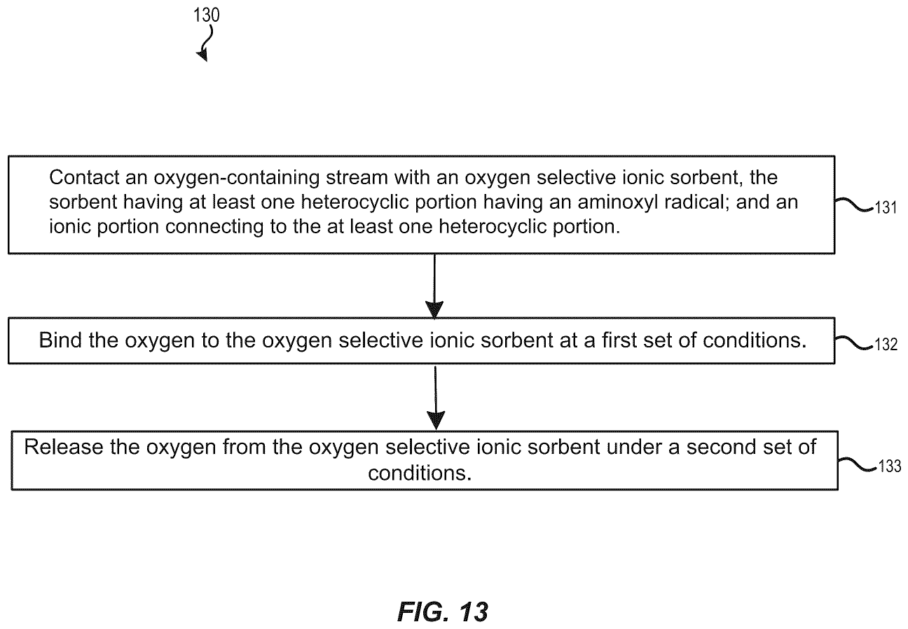

FIG. 13 illustrates an example method 130 for capturing molecular oxygen from a stream containing molecular oxygen. At operation 131, an oxygen-containing stream is contacted with an oxygen selective ionic sorbent. The oxygen selective ionic sorbent, in some examples, has at least one heterocyclic portion having an aminoxyl radical, and an ionic portion connecting to the at least one heterocyclic portion. In some examples, the oxygen selective ionic sorbent has first and second heterocyclic portions, each having an aminoxyl radical; and an ionic portion connecting to both of the heterocyclic portions. In examples, the oxygen selective ionic sorbent may correspond to any of Formulas III-VII above.

In some examples, the heterocyclic portions are derived from 4-hydroxy-2,2,6,6-tetramethyl-piperdine-1-oxyl (e.g. TEMPOL). In some examples, the ionic portion is derived from 1-methylimidazole or imidazole.

In some examples, by the binding of a single aminoxyl radical to a single molecular oxygen molecule, a 1:1 monodentate complex is formed. In some examples, by the binding of two aminoxyl radicals to a single molecular oxygen molecule, a 2:1 supramolecular complex is formed.

At operation 132, the oxygen is bound to the oxygen selective ionic sorbent at a first set of conditions (e.g. the oxygen is chemically absorbed by the sorbent). The oxygen may bind to an aminoxyl radical of the oxygen selective ionic sorbent. The first conditions may include an initial temperature (for example, about room temperature, between about 25° C. and about 30° C.) and/or an initial temperature (for example, under positive or vacuum conditions). In some examples, releasing the molecular oxygen from the oxygen selective ionic sorbent regenerates the oxygen selective ionic sorbent.

At operation 133, the oxygen is released form the oxygen selective ionic sorbent under a second set of conditions. The second conditions may include a subsequent temperature (for example, between about 60° C. and about 80° C.), and/or a subsequent pressure (for example, about 60 psi). In some examples, the released high purity oxygen is then collected. In some examples, the high purity oxygen may have a purity of at least 50%. In some examples, the high purity oxygen may have a purity of at least 60%. In some examples, the high purity oxygen may have a purity of at least 70%. In some examples, the high purity oxygen may have a purity of at least 80%. In some examples, the high purity oxygen may have a purity of at least 90%. In some examples, the high purity oxygen may have a purity of at least 95%. In some examples, the high purity oxygen may have a purity of at least 98%. In some examples, the high purity oxygen may have a purity of between about 75% and 100%. In some examples, the high purity oxygen may have a purity of between about 90% and 100%. In some examples, the high purity oxygen may have a purity of between about 85% and 100%. In some examples, the high purity oxygen may have a purity of between about 95% and 100%.

In examples, method 130 may be carried out with the oxygen selective ionic sorbent utilized as a solvent liquid. In examples, method 130 may be carried out with the oxygen selective loaded onto a substrate (for example, onto porous silica particles such as mesoporous silica particles).

### EXAMPLES

### Example 1

In Example 1, biradical TSIL-TEMPO compounds as described above were generated. In a first step, glassware was oven-dried and cooled under vacuum. Reactions were carried out under nitrogen gas. ¹H and ¹³C nuclear magnetic resonance spectroscopy (NMR) spectra were acquired in CDCl₃ or DMSO-d₆ at ambient temperature (25° C.) on a Bruker 400 MHz Avance III spectrometer equipped with a 5 mm BBFO SmartProbe. All chemical shifts were reported in the standard notation of parts per million using the peak of the residual proton or carbon signal of CDCl₃ (¹H NMR δ 7.26 and ¹³C NMR δ 77.36 ppm) or DMSO-d₆ (¹H NMR δ 2.50 and ¹³C NMR δ 39.52 ppm) as an internal reference. NMR samples of the TSIL-TEMPO compounds were reduced with phenylhydrazine prior to obtaining spectra. Mass spectrometry was performed by direct infusion on a Thermo ESI oribitrap spectrometer.

Refer also to FIG. 8. 5.0 g (0.029 mmol, 1 eq) hydroxy-TEMPO was dissolved in 45 mL of dry acetone. 1.16 g of NaH (60% NaH in mineral oil, 0.029 mol, 1 eq) was added and the solution allowed to stir for 10 minutes at room temperature. Then, 5.2 mL (9.4 g, 0.044 mol, 1.5 eq) 1,4-dibromobutane was added and the reaction was stirred at room temperature overnight. Solvent was removed by rotary evaporation, and the residue was dissolved in water and extracted with DCM three times. The combined organic layers were dried over Na₂SO₄ and concentrated under reduced pressure.

The crude intermediate was purified by flash chromatography over silica gel with a solvent gradient of 0-15% EtOAc in hexane. Drying under high vacuum afforded 1.5 g (18% yield) of the intermediate. ¹H NMR (400 MHz, Chloroform-d) results corresponded to: δ 3.61 (tt, J=10.0, 3.9 Hz, 1H), 3.44 (q, J=6.6 Hz, 4H), 2.07-1.98 (m, 2H), 1.94 (dd, J=8.4, 6.5 Hz, 2H), 1.81-1.64 (m, 4H), 1.40 (s, 6H), 1.28 (d, J=8.0 Hz, 6H). ¹³C NMR (101 MHz, Chloroform-d) results corresponded to: δ 70.11, 67.37, 60.72, 44.41, 33.88, 29.83, 28.75, 28.46, 21.55.

0.13 g (2.0 mmol, 0.6 eq) imidazole and 0.3824 g (3 mmol) K₂CO₃ were suspended in 6 mL of dry acetone followed by the addition of 1.0 g (3.3 mmol, 1 eq) of the TEMPO butyl bromide intermediate while stirring. The reaction mixture was refluxed for 36 h, then stirred at 30 C for an additional 48 h. 0.36 g (2.0 mmol, 0.6 eq) KPF₆ was added to the flask and reflux was resumed for 24 h, followed by stirring at room temperature for an additional 24 h. The crude product was purified by flash chromatography using a silica gel column and two solvent systems: 1.) 0-20% ethyl acetate in hexanes to remove impurities, and 2.) 5% methanol in DCM to elute the product. After drying under vacuum, 246 mg (11%) of the biradical TSIL-TEMPO compounds was obtained. MS: m/z=+521.41 (observed), [M+]=521.77 (calculated). ¹H NMR (400 MHz, DMSO-d₆) results corresponded to: δ 9.17 (q, J=2.6, 1.7 Hz, ¹H), 7.80 (d, J=1.6 Hz, 2H), 4.18 (t, J=7.2 Hz, 4H), 3.52 (tt, J=11.0, 4.1 Hz, 2H), 3.40 (t, J=6.2 Hz, 4H), 1.89-1.79 (m, 8H), 1.49-1.40 (m, 4H), 1.28-1.19 (m, 4H), 1.08 (s, 12H), 1.04 (s, 12H). ¹³C NMR (101 MHz, DMSO-d₆) results corresponded to: δ 135.98, 128.32, 122.47, 121.32, 70.03, 66.45, 60.18, 57.87, 54.90, 48.78, 44.63, 40.15, 39.94, 39.73, 39.52, 39.31, 39.10, 38.89, 32.43, 26.64, 26.25, 21.04, 20.50.

### Example 2

In order to analyze potential process and economic advantages of use of the TSIL-TEMPO compounds described herein, an example preliminary techno-economic and life-cycle assessment (TEA/LCA) were conducted for air separation using an proposed TSIL-based vacuum pressure swing adsorption (VPSA) technology operating at ambient temperature. This analysis is intended as a particular example, and is not intended to limit the disclosure to these conditions, systems, or applications. A system analyzed may include one such as FIG. 12. In the particular example, air is compressed and sent to the beds filled with TSIL-TEMPO sorbent. A number of sorbent beds are operated in parallel with different absorption/desorption schedule to continuously produce oxygen. In the adsorption step, oxygen is absorbed under pressure, while nitrogen and other gases in the air do not interact with the sorbent and are directly vented to atmosphere or downstream processes. In the desorption step, then the bed is depressurized to release oxygen product. In this particular example, the main energy consumption of the VPSA technology is the electricity used in air compressor and oxygen vacuum compressor.

In this particular study, a process model was developed in Aspen Plus V14 to estimate the mass and energy balance, where the VPSA beds were modeled as a component separator due to the lack of breakthrough curves and other necessary experimental data for developing a rigorous adsorption cycle model. The oxygen recovery rate (the percent of oxygen in air recovered in the product stream) was set to 50%, similar to that of a commercial VPSA-based air separation technology using zeolite to adsorb nitrogen. The experimentally measured oxygen loading data (discussed in sections above) at different oxygen partial pressure was used to calculate oxygen uptake on the sorbent at different adsorption and desorption pressures. The plant scale was set to 19.7 ton/day, similar to commercial VPSA technology. In the proposed process, the VPSA beds were sized based on a 200 sec adsorption time and 25 sec desorption time for a 15 wt % oxygen uptake on the sorbent, observed through the laboratory operation. The equipment price was estimated using Aspen Process Economic Analyzer (APEA) V14. An overnight cost approach used by PEP Yearbook was used to calculate the minimum oxygen selling price with 15% return on investment before taxes in 2020 U.S. dollars. The prices of TSIL-TEMPO sorbent, cooling water, and electricity were set to $300/kg, ¢12.7/MGAL, ¢3.77/kWh, respectively, to calculate the variable cost. A preliminary LCA study was conducted to estimate the cradle-to-gate greenhouse gas (GHG) emission per kilogram of oxygen produced based on the life cycle inventory data generated from the Aspen Plus model. This study considered greenhouse gas (GHG) emission associated with utility consumption, of which the carbon intensity of the U.S. grid was collected from GREET database (466 kg CO2eq/MWh electricity).

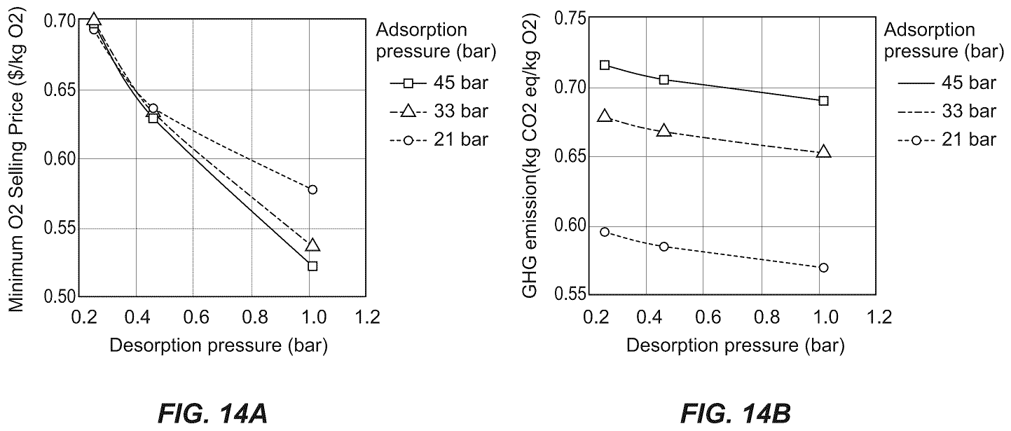

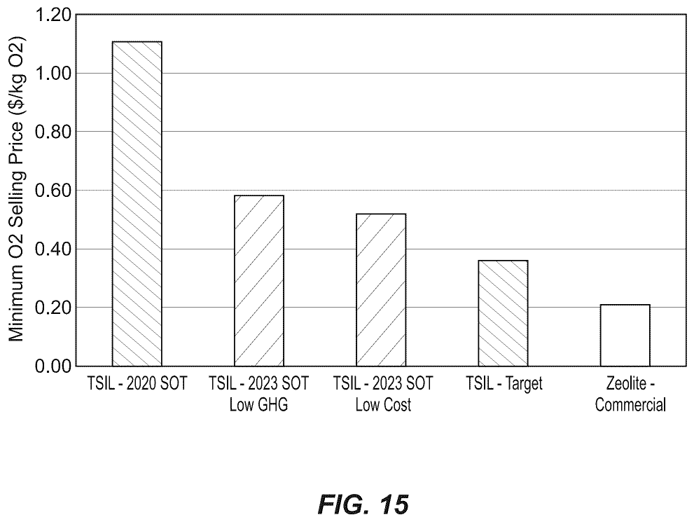

A sensitivity study was conducted to evaluate the impact of adsorption and desorption pressure on the economic and environmental performance of the proposed air separation technology, of which the results are shown in Table 1, FIG. 14A, and FIG. 14B. Higher adsorption pressure and lower desorption pressure are preferred to maximize the working capacity of the sorbent (oxygen removal per kg sorbent per cycle) and reduce the capital investment of the adsorption beds. At meanwhile it will result in high power consumptions and capital investment for the air compressor and oxygen vacuum compressor, as well as higher GHG emission. An adsorption pressure of 45 bar (corresponding to a 60 psig oxygen 2 adsorption pressure) and a desorption pressure of 1 bar gives the lowest estimated minimum oxygen selling price ($0.52/kg). An adsorption pressure of 21 bar (corresponding to 20 psig oxygen adsorption pressure) and a desorption pressure of 1 bar gives the lowest estimated GHG emission (0.57 kg carbon dioxide eq/kg oxygen). The benchmark GHG footprint of oxygen in the 2022 GREET model is 0.20 kg carbon dioxide eq/kg oxygen 2, estimated based on the large-scale cryogenic process. FIG. 15 provides a comparison with the commercial technology and particular TSIL-TEMPO technology example. A TEA based on one single experimental point available at the time with an absorption pressure of 60 psig, a desorption pressure of 15 millitorr, a sorbent working capacity of 15 wt % oxygen gave an estimated minimum oxygen selling price of $1.11/kg for the TSIL-TEMPO technology. A target case was evaluated, assuming oxygen can be regenerated at a much higher pressure with the same sorbent working capacity. Oxygen loading data collected (as described previously above) enabled a data driven sensitivity study to identify an optimal adsorption and desorption pressure for this particular example to simultaneously reduce cost and GHG emission of the proposed TSIL-TEMPO technology. With the current state of technology (SOT), the minimum oxygen selling price of the TSIL-TEMPO technology is higher than that of the commercially available zeolite technology, because of its higher absorption pressure (for example, greater than 21 bar as compared to 1.2 bar). One important advantage of TSIL-TEMPO sorbent over zeolite sorbent for oxygen production is that TSIL-TEMPO absorbs oxygen instead of nitrogen, and therefore has the potential to produce oxygen product with a much higher purity. The proposed TSIL technology may become competitive or even better than the industrial benchmark with further development to improve oxygen adsorption at relatively lower pressure and reduce sorbent manufacturing cost.

TABLE 1
Performance and Economic Measures for Example 2

| Cases | 1 | 2 | 3 | 4 | 5 | 6 | 7 | 8 | 9 |
|---|---|---|---|---|---|---|---|---|---|
| Adsorption | | | | | | | | | |
| O₂ partial pressure | 5.15 | 5.15 | 5.15 | 3.77 | 3.77 | 3.77 | 2.39 | 2.39 | 2.39 |
| (bar) | | | | | | | | | |
| O₂ loading (wt %) | 15 | 15 | 15 | 11 | 11 | 11 | 7.5 | 7.5 | 7.5 |
| Desorption | | | | | | | | | |
| O₂ partial pressure | 1.01 | 0.46 | 0.25 | 1.01 | 0.46 | 0.25 | 1.01 | 0.46 | 0.25 |
| (bar) | | | | | | | | | |
| O₂ loading (wt %) | 4 | 2 | 1 | 4 | 2 | 1 | 4 | 2 | 1 |
| Adsorption pressure ⁽¹⁾ | 45 | 45 | 45 | 33 | 33 | 33 | 21 | 21 | 21 |
| (bar) | | | | | | | | | |
| Working capacity | 11 | 13 | 14 | 7 | 9 | 10 | 3.5 | 5.5 | 6.5 |
| (wt %) | | | | | | | | | |
| Sorbent makeup ⁽²⁾ | 0.07 | 0.06 | 0.06 | 0.11 | 0.09 | 0.08 | 0.23 | 0.15 | 0.12 |
| (kg/kg O₂) | | | | | | | | | |
| Utility consumption | | | | | | | | | |
| Electricity (kWh/kg | 1.457 | 1.487 | 1.511 | 1.376 | 1.407 | 1.431 | 1.202 | 1.233 | 1.257 |
| O₂) | | | | | | | | | |
| Cooling water (Gal/kg | 52.17 | 51.62 | 51.09 | 49.19 | 48.64 | 48.12 | 42.95 | 42.40 | 41.88 |
| O₂) | | | | | | | | | |

⁽¹⁾ With an oxygen recovery rate of 50%
⁽²⁾ Assuming a sorbent lifetime of 1 year

Having described the preferred aspects and implementations of the present disclosure, modifications and equivalents of the disclosed concepts may readily occur to one skilled in the art. However, it is intended that such modifications and equivalents be included within the scope of the claims which are appended hereto.

For the purposes of this application, directional terms such as “upper,” “lower,” “upward,” and “downward” are intended to be descriptive with reference to the disclosure above and, where applicable, in relation to the orientation shown in the Figures for clarity. The examples as practiced and included in the scope of the claims may include examples where the systems and devices are in a different orientation.

While particular uses of the technology have been illustrated and discussed above, the disclosed technology can be used with a variety of environments in accordance with many examples of the technology. The above discussion is not meant to suggest that the disclosed technology is only suitable for implementation within the environments shown and described above. As should be appreciated, the various aspects described with respect to the figures herein are not intended to limit the technology to the particular aspects described. Accordingly, additional configurations can be used to practice the technology herein and/or some aspects described can be excluded without departing from the methods and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or operations are disclosed only as illustrative aspects. The scope of the technology is defined by the following claims and any equivalents therein. Therefore, the specific structure, acts, or operations are disclosed only as illustrative aspects. The scope of the technology is defined by the following claims and any equivalents therein. Examples of the disclosure may be described according to the following aspects.
Aspect 1. A method for capturing molecular oxygen from a stream containing the molecular oxygen, comprising: contacting the stream with an oxygen selective ionic sorbent, the oxygen selective ionic sorbent having a structure comprising: at least a first heterocyclic portion and a second heterocyclic portion, each of the first heterocyclic portion and the second heterocyclic portion including an aminoxyl radical; and an ionic portion connected at a first end to the first heterocyclic portion and at a second end to the second heterocyclic portion; binding the molecular oxygen to the oxygen selective ionic sorbent at the aminoxyl radical of at least one of the first heterocyclic portion and the second heterocyclic portion, under a first set of conditions; and releasing the molecular oxygen from the oxygen selective ionic sorbent under a second set of conditions.
Aspect 2. The method of aspect 1, wherein the ionic portion comprises an imidazolium ion.
Aspect 3. The method of any of aspects 1-2, wherein the first condition comprises a pressure of at least about 60 psig.
Aspect 4. The method of any of aspects 1-3, wherein the second condition comprises a vacuum pressure.
Aspect 5. The method of any of aspects 1-4, further comprising: forming, by the binding of a single aminoxyl radical to a single molecular oxygen molecule, a 1:1 monodentate complex.
Aspect 6. The method of any of aspects 1-5, further comprising: forming, by the binding of two aminoxyl radicals to a single molecular oxygen molecule, a 2:1 supramolecular complex.
Aspect 7. The method of any of aspects 1-6, further comprising: regenerating the oxygen selective ionic sorbent by releasing the molecular oxygen from the oxygen selective ionic sorbent.
Aspect 8. The method of any of aspects 1-7, wherein the first and second heterocyclic portions are derived from 4-hydroxy-2,2,6,6-tetramethyl-piperdine-1-oxyl.
Aspect 9. The method of any of aspects 1-8, wherein the ionic portion is derived from imidazole.
Aspect 10. The method of any of aspects 1-9, wherein the oxygen selective ionic sorbent has the structure of Formula (I):

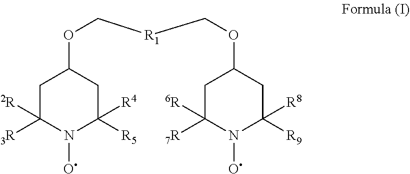

Aspect 11. The method of any of aspects 1-10, further comprising collecting the released molecular oxygen.
Aspect 12. The method of aspect 11, wherein the collected molecular oxygen has a purity of at least about 95%.
Aspect 13. The method of any of aspects 1-12, wherein a plurality of molecules of the oxygen selective ionic sorbent are absorbed onto a plurality of mesoporous silica particles.
Aspect 14. An oxygen selective ionic liquid comprising: an oxygen selective ionic sorbent of Formula (I):

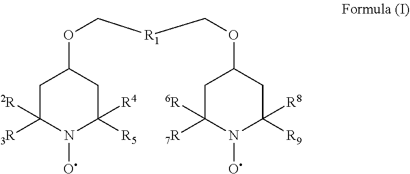

wherein: R₁ comprises an ionic portion.
Aspect 15. The oxygen selective ionic liquid of aspect 14, wherein at least one of R₂, R₃, R₄, R₅, R₆, R₇, R₈, and R₉ comprise a methyl group.
Aspect 16. The oxygen selective ionic liquid of any of aspects 14-15, wherein an orientation of R₂, R₃, R₄, and R₅ shield a first aminoxyl radical of Formula (I), and wherein an orientation of R₆, R₇, R₈, and R₉ shield a second aminoxyl radical of Formula (I).
Aspect 17. The oxygen selective ionic liquid of any of aspects 14-16, wherein the oxygen selective ionic sorbent comprises Formula (II):

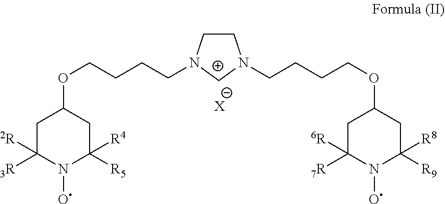

Aspect 18. The oxygen selective ionic liquid any of aspects 14-17, wherein R₁ is derived from 1-methylimidazole.
Aspect 19. The oxygen selective ionic liquid of any of aspects 14-18, wherein the oxygen selective ionic sorbent is derived from 4-hydroxy-2,2,6,6-tetramethyl-piperdine-1-oxyl.
Aspect 20. The oxygen selective ionic liquid of any of aspects 14-19, wherein at least one of a first aminoxyl radical and a second aminoxyl radical of Formula (I) binds to molecular oxygen under a first condition.
Aspect 21. The oxygen selective ionic liquid of aspect 20, wherein the molecular oxygen is released from the aminoxyl radical of Formula (I) under a second condition.
Aspect 22. The oxygen selective ionic liquid of any of aspects 14-21, wherein a plurality of molecules of the oxygen selective ionic sorbent are absorbed onto a plurality of mesoporous silica particles.
Aspect 23. The oxygen selective ionic liquid of any of aspects 14-22, wherein, in the presence of molecular oxygen, the oxygen selective ionic liquid absorbs molecular oxygen to form at least one of a 1:1 monodentate complex and a 2:1 supramolecular complex.
Aspect 24. The oxygen selective ionic liquid of any of aspects 14-23, wherein the oxygen selective ionic liquid has a vapor pressure less than a vapor pressure of TEMPO.
Aspect 25. An energy conversion system comprising: a unit operation vessel; an inlet of the vessel by which an inlet stream comprising molecular oxygen flows into the unit operation vessel; a plurality of mesoporous silica particles contained within the unit operation vessel, each of the plurality of mesoporous silica particles being loaded with an oxygen selective ionic liquid comprising: at least one first heterocyclic portion including an aminoxyl radical; and an ionic portion connected to at least one heterocyclic portion, wherein the molecular oxygen of the inlet stream contacts the oxygen selective ionic liquid within the unit operation vessel, and wherein, upon contact, the molecular oxygen binds to the oxygen selective ionic liquid at the aminoxyl radical under a first set of conditions; and an outlet of the vessel by which an outlet stream flows out of the unit operation vessel.
Aspect 26. The energy conversion system of aspect 25, wherein the system comprises an oxy-combustion system.
Aspect 27. The energy conversion system of any of aspects 25-26, wherein the unit operation vessel comprises one of a fluidized bed or a packed bed.
Aspect 28. The energy conversion system any of aspects 25-27, wherein, under the first set of conditions, the outlet stream comprises molecular oxygen content that is lower than a molecular oxygen content of the inlet stream.
Aspect 29. The energy conversion system of any of aspects 25-28, wherein the unit operation vessel is capable of being operated under at least the first set of conditions and a second set of conditions.
Aspect 30. The energy conversion system of aspect 29, wherein, under the second set of conditions, the molecular oxygen is released from the oxygen selective ionic liquid, and wherein the outlet stream consists essentially of the released molecular oxygen.
Aspect 31. The energy conversion system of any of aspects 25-30, further comprising a molecular oxygen collection vessel downstream of the unit operation vessel.
Aspect 32. The energy conversion system of any of aspects 25-31, wherein a molecule of the oxygen selective ionic liquid has the structure of Formula (I):

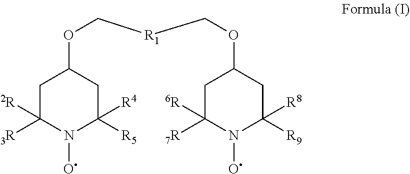

wherein: R₁ comprises an ionic portion.
Aspect 33. The energy conversion system of any of aspects 25-32, wherein a molecule of the oxygen selective ionic liquid has the structure of Formula (II):

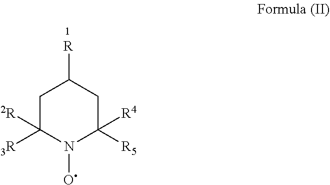

wherein: R₁ comprises an ionic portion.

What is claimed is:

1. A method for capturing molecular oxygen from a stream containing the molecular oxygen, comprising:
contacting the stream with an oxygen selective ionic sorbent, the oxygen selective ionic sorbent having a structure comprising:
at least a first heterocyclic portion and a second heterocyclic portion, each of the first heterocyclic portion and the second heterocyclic portion including an aminoxyl radical; and
an ionic portion connected at a first end to the first heterocyclic portion and at a second end to the second heterocyclic portion;
binding the molecular oxygen to the oxygen selective ionic sorbent at the aminoxyl radical of at least one of the first heterocyclic portion and the second heterocyclic portion, under a first set of conditions; and
releasing the molecular oxygen from the oxygen selective ionic sorbent under a second set of conditions.

2. The method of claim 1, wherein the ionic portion comprises an imidazolium ion or the ionic portion is derived from imidazole.

3. The method of claim 1, wherein the first set of conditions comprises a first pressure, the second set of conditions comprises a second pressure, and the first pressure is greater than the second pressure.

4-6. (canceled)

7. The method of claim 1, further comprising:
regenerating the oxygen selective ionic sorbent by releasing the molecular oxygen from the oxygen selective ionic sorbent after:
forming, by the binding of a single aminoxyl radical to a single molecular oxygen molecule, a 1:1 monodentate complex; or
forming, by the binding of two aminoxyl radicals to a single molecular oxygen molecule, a 2:1 supramolecular complex.

8. The method of claim 1, wherein the first and second heterocyclic portions are derived from 4-hydroxy-2,2,6,6-tetramethyl-piperdine-1-oxyl.

9. (canceled)

10. The method of claim 1, wherein the oxygen selective ionic sorbent has the structure of Formula (I):

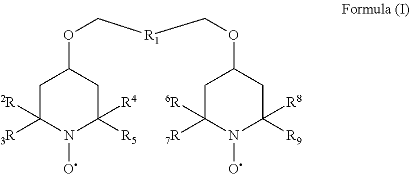

11. (canceled)

12. The method of claim 11, further comprising collecting the released molecular oxygen, the collected molecular oxygen having a purity of at least about 95%.

13. The method of claim 11, wherein a plurality of molecules of the oxygen selective ionic sorbent are absorbed onto a plurality of mesoporous silica particles.

14. An oxygen selective ionic liquid comprising:
an oxygen selective ionic sorbent of Formula (I): 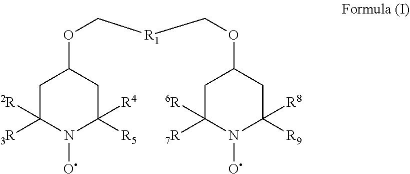
wherein:
R¹ comprises an ionic portion.

15. The oxygen selective ionic liquid of claim 14, wherein at least one of R₂, R₃, R₄, R₅, R₆, R₇, R₈, and R₉ comprise a methyl group.

16. The oxygen selective ionic liquid of claim 14, wherein an orientation of R₂, R₃, R₄, and R₅ shield a first aminoxyl radical of Formula (I), and wherein an orientation of R₆, R₇, R₈, and R₉ shield a second aminoxyl radical of Formula (I).

17. The oxygen selective ionic liquid of claim 14, wherein the oxygen selective ionic sorbent comprises Formula (II):

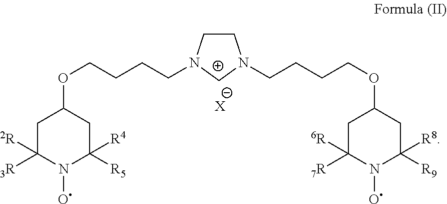

18. (canceled)

19. (canceled)

20. The oxygen selective ionic liquid of claim 14, wherein:
at least one of a first aminoxyl radical and a second aminoxyl radical of Formula (I) binds to molecular oxygen under a first condition; and
the molecular oxygen is released from the aminoxyl radical of Formula (I) under a second condition.

21. (canceled)

22. The oxygen selective ionic liquid of claim 14, wherein a plurality of molecules of the oxygen selective ionic sorbent are absorbed onto a plurality of mesoporous silica particles.

23. The oxygen selective ionic liquid of claim 14, wherein, in the presence of molecular oxygen, the oxygen selective ionic liquid absorbs molecular oxygen to form at least one of a 1:1 monodentate complex and a 2:1 supramolecular complex.

24. (canceled)

25. An energy conversion system comprising:
a unit operation vessel;
an inlet of the vessel by which an inlet stream comprising molecular oxygen flows into the unit operation vessel;
a plurality of mesoporous silica particles contained within the unit operation vessel, each of the plurality of mesoporous silica particles being loaded with an oxygen selective ionic liquid comprising:
at least one first heterocyclic portion including an aminoxyl radical; and
an ionic portion connected to at least one heterocyclic portion,
wherein the molecular oxygen of the inlet stream contacts the oxygen selective ionic liquid within the unit operation vessel, and
wherein, upon contact, the molecular oxygen binds to the oxygen selective ionic liquid at the aminoxyl radical under a first set of conditions; and
an outlet of the vessel by which an outlet stream flows out of the unit operation vessel.

26. The energy conversion system of claim 25, wherein the system comprises an oxy-combustion system.

27. (canceled)

28. The energy conversion system of claim 25, wherein:
the unit operation vessel is capable of being operated under at least the first set of conditions and a second set of conditions:
under the first set of conditions, the outlet stream comprises molecular oxygen content that is lower than a molecular oxygen content of the inlet stream; and
under the second set of conditions, the molecular oxygen is released from the oxygen selective ionic liquid, and wherein the outlet stream consists essentially of the released molecular oxygen.

29. (canceled)

30. (canceled)

31. The energy conversion system of claim 25, further comprising a molecular oxygen collection vessel downstream of the unit operation vessel.

32. The energy conversion system of claim 25, wherein a molecule of the oxygen selective ionic liquid has the structure of Formula (I): 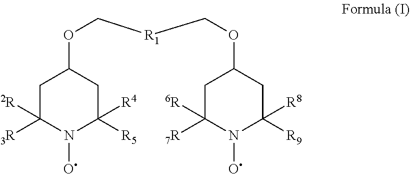
wherein:
R₁ comprises an ionic portion; and further wherein a molecule of the oxygen selective ionic liquid has the structure of Formula (II): 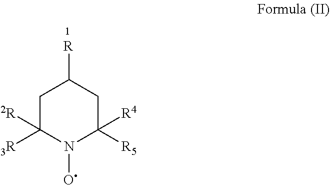
wherein:
R₁ comprises an ionic portion.

33. (canceled)
